(19) United States
(12) Patent Application Publication
(10) Pub. No.: US 2017/0032374 A1
(43) Pub. Date: Feb. 2, 2017

(54) DETERMINING RISK OF TRANSACTIONS BASED ON PATTERNS OF WIRELESS DEVICES OBSERVED BY A USER TERMINAL

(71) Applicant: CA, INC., New York, NY (US)

(72) Inventors: Chetan Doddamani, Bengaluru (IN); Anand Manvi, Bengaluru (IN); Shashanka Arnady, Bengaluru (IN); Prasanna Babu Krishnappa, Bengaluru (IN); Arun Shetty, Bengaluru (IN)

(73) Assignee: CA, INC., New York, NY (US)

(21) Appl. No.: 14/810,648

(22) Filed: Jul. 28, 2015

(51) Int. Cl. G06Q 20/40; G06Q 20/32

(52) U.S. Cl. CPC G06Q 20/4016; G06Q 20/405; G06Q 20/3226

(57) ABSTRACT

A method of performing operations on a processor of a financial transaction processing system, includes receiving from a merchant node an eCommerce authentication request for a pending eCommerce transaction associated with a user terminal. The eCommerce authentication request contains transaction information that comprises a user terminal identifier and a reported list of wireless device identifiers that are observed by the user terminal. A risk score is generated for the pending eCommerce transaction based on comparison of the reported list of wireless device identifiers to a registered list of wireless device identifiers which has been associated with the user terminal identifier. Authentication of the eCommerce authentication request is controlled based on the risk score. Related computer nodes of financial transaction processing systems and user terminals are disclosed.

### BACKGROUND

The present disclosure relates to transaction risk processing systems.

Financial transactions relating to purchasing goods and services are predominately paid for using credit accounts and debit accounts that an account owner accesses through associated credit cards and debit cards. Financial transaction processing systems provide verification processes that allow merchants to verify that account information is valid and the account owner has sufficient credit or debit funds to cover the purchase.

When a purchaser is located at the merchant's facility, the merchant is responsible for authenticating that the purchaser is the account owner by, for example, comparing the purchaser's signature to an existing signature on the card, examining a picture ID of the purchaser, or providing a password.

For purchases made through a merchant's website and other electronic commerce (“eCommerce”) transactions (known as a card-not-present transactions (CNP)), financial transaction processing systems can use eCommerce authentication processes that challenge the purchaser to provide a security code that is used to authenticate that the purchaser is the account owner or is otherwise authorized by the account owner. The security code may be a password, personal identification number (PIN), or other information known to the account owner such as a one time password received through e-mail, etc. Purchasers can find eCommerce authentication processes undesirable due to the need to remember security codes and the requirement to successfully complete additional process steps for purchases. Merchants can find eCommerce authentication processes undesirable because of the fees charged for use of such processes and lost sales due to purchasers abandoning transactions during the eCommerce authentication processes.

### SUMMARY

Some embodiments disclosed herein are directed to a method of performing operations on a processor of a financial transaction processing system. The method includes receiving from a merchant node an eCommerce authentication request for a pending eCommerce transaction associated with a user terminal. The eCommerce authentication request contains transaction information that comprises a user terminal identifier and a reported list of wireless device identifiers that are observed by the user terminal. A risk score is generated for the pending eCommerce transaction based on comparison of the reported list of wireless device identifiers to a registered list of wireless device identifiers which has been associated with the user terminal identifier. Authentication of the eCommerce authentication request is controlled based on the risk score.

Some other embodiments disclosed herein are directed to a computer node of a financial transaction processing system that includes a processor and a memory. The memory is coupled to the processor and includes computer readable program code that when executed by the processor causes the processor to perform operations. The operations include receiving from a merchant node an eCommerce authentication request for a pending eCommerce transaction associated with a user terminal. The eCommerce authentication request contains transaction information that comprises a user terminal identifier and a reported list of wireless device identifiers that are observed by the user terminal. The operations further include generating a risk score for the pending eCommerce transaction based on comparison of the reported list of wireless device identifiers to a registered list of wireless device identifiers which has been associated with the user terminal identifier, and controlling authentication of the eCommerce authentication request based on the risk score.

Some other embodiments disclosed herein are directed to a user terminal that includes a processor, a memory coupled to the processor, and a radio transceiver configured to communicate with wireless devices. The memory includes computer readable program code that when executed by the processor causes the processor to perform operations. The operations include generating a list of wireless device identifiers for wireless devices that are presently observable by the radio transceiver, and generating an eCommerce authentication request for a pending eCommerce transaction. The eCommerce authentication request includes the list of wireless device identifiers, an account number for the eCommerce transaction, and an amount of the pending eCommerce transaction. The operations further include communicating the eCommerce authentication request to a merchant node.

Other methods, computer nodes of financial transaction processing systems, and user terminals according to embodiments will be or become apparent to one with skill in the art upon review of the following drawings and detailed description. It is intended that all such additional methods, computer nodes of financial transaction processing systems, and user terminals be included within this description and protected by the accompanying claims.

### BRIEF DESCRIPTION OF THE DRAWINGS

Aspects of the present disclosure are illustrated by way of example and are not limited by the accompanying drawings. In the drawings:

FIG. 1 is a block diagram of a financial transaction processing system that includes an authentication gateway node that controls which eCommerce authentication requests are selected for authentication by an authentication node, in accordance with some embodiments;

FIGS. 2-10 are flowcharts that illustrate operations that may be performed by an authentication gateway node to control which eCommerce authentication requests are authenticated by an authentication node, in accordance with some embodiments; and

FIG. 11 is a block diagram of a computer system that may be incorporated into various components of the system of FIG. 1 in accordance with some embodiments.

### DETAILED DESCRIPTION

Various embodiments will be described more fully hereinafter with reference to the accompanying drawings. Other embodiments may take many different forms and should not be construed as limited to the embodiments set forth herein. Like numbers refer to like elements throughout.

The rate of fraud occurring with eCommerce transactions continues to increase with the increasing number of various types of user terminals (e.g., smart phones, portable computing devices, etc.) that are used to conduct eCommerce transactions. Reliance on a user terminal identifier associated with an eCommerce transaction is not sufficient to prevent fraud, because for a fraudulent eCommerce transaction a fraudster can configure a user terminal to provide a user terminal identifier that is known to be associated with an account owner but different from the identifier for the user terminal operated by the fraudster. Various embodiments of the present disclosure provides an extra level of security to identify such fraudulent eCommerce transactions.

Some embodiments of the present disclosure are directed to a financial transaction processing system that determines the risk of an eCommerce transaction from a user terminal based on comparison of the wireless devices that are presently observable by the user terminal to a list of wireless devices that have been earlier registered as being associated with the user terminal. For example, when a user terminal generates an eCommerce transaction that indicates the wireless terminal is presently paired to a smart watch and the system determines that the smart watch has been earlier registered with an association to the user terminal, the system can generate a risk score that indicates the eCommerce transaction has a low risk of fraud. An eCommerce transaction can be any type of financial transaction that involves transmitting funds or data over an electronic data network, such as the Internet.

A credit card owner may proactively register with the financial transaction processing system the various wireless devices that are owned by the credit card owner and which can be wirelessly connected to a user terminal. Alternatively or additionally, the financial transaction processing system can generate a list of wireless devices that are associated with a user terminal by learning over time what wireless devices are observable by the user terminal at the time of various eCommerce transactions. The system can generate a list of wireless devices that are determined to be observable by the user terminal during the eCommerce transactions. The system may use feedback regarding completion of successful authentication processes which authenticated the user of the user terminal for one or more eCommerce transactions before adding one or more observed wireless devices to a registered list associated with the user terminal.

More than one list of wireless devices may be associated with the same user terminal. For example, different lists of wireless devices associated with a user terminal may be generated based on observing patterns of wireless devices that are identified as being observable during eCommerce transactions from the user terminal as a function of the time of day, the day of week, geolocation, movement (e.g., eCommerce transaction arising while riding in a vehicle), and/or other patterns. For example, different lists of wireless devices can generated for association with a user terminal based on different geolocations or other criteria, such as at the card owner's home, work, vehicle, etc.

Thus, for example, when the credit card owner operates a user terminal to generate an eCommerce transaction while within the owner's car, the eCommerce transaction can include information that indicates the user terminal is presently paired to the car's Bluetooth transceiver having an identifier that is determined by the financial transaction processing system to match a wireless device identifier that has earlier been associated with the user terminal. The system can therefore determine that the risk of the eCommerce transaction being fraudulent is low. The eCommerce transaction may also include information that indicates the user terminal is also paired to a smart watch Bluetooth transceiver having an identifier that is determined by the financial transaction processing system to match another wireless device identifier that has earlier been associated with the user terminal. The system can therefore match two reported wireless device identifiers to entries in a registered list of wireless device associated with the mobile terminal identifier, and determine that the risk of the eCommerce transaction being fraudulent is further reduced relative to identifying a single match.

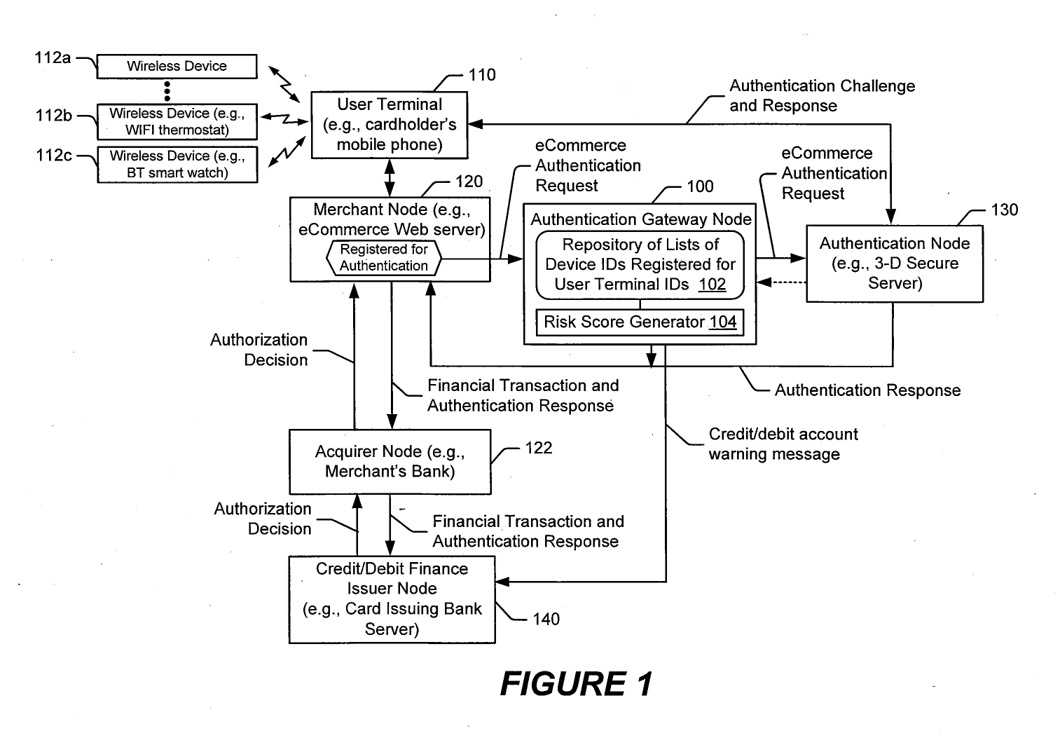

FIG. 1 is a block diagram of a financial transaction processing system that includes an authentication gateway node 100 (e.g., a computer system, computer server, etc.) that controls which eCommerce authentication requests are authenticated by an authentication node 130 in accordance with some embodiments. Although some embodiments are described in the context of authenticating credit card and/or debit card transactions for purchases made through a merchant's node 120 (e.g., merchant's eCommerce Web server), the embodiments disclosed herein are not limited thereto and can be used with other types of authentication processes.

Referring to FIG. 1, a person who is purchasing an item (purchaser) operates a user terminal 110 to select items to be purchased, and provides (e.g., types, electronically scans, executes an application on the user terminal 110, etc.) cardholder information that can include any one or more of: an account number (e.g., credit card number and/or debit card number); customer name; account verification information; cardholder's name; an expiration date for the card; a card verification value (CVV); the cardholder's home address; and the purchaser's shipping address. The cardholder information is communicated by the user terminal 110 to the merchant node 120.

Pursuant to embodiments disclosed herein, the user terminal 110 also communicates as part of the eCommerce transaction to the merchant node 120 a list of wireless device identifiers of wireless devices 112a . . . 112c that are observed by the user terminal 110 through one or more wireless transceiver interfaces of the user terminal 110. The list may include wireless device identifiers of wireless devices that are observable through any type of wireless communication technology by the user terminal 110. In one example embodiment, the list of wireless device identifiers can include a list of Bluetooth devices that indicated to have established a traffic data connection through completing pairing to the user terminal 110, but may alternatively or additionally list Bluetooth devices that are not paired to the user terminal 110 but are presently observed to be within communication range of a Bluetooth transceiver of the user terminal 110 through operations for discovering Bluetooth devices. In another example embodiment, the list of wireless device identifiers can include a list of wireless local area network, WLAN, (e.g., WIFI) devices that are indicated to have established a traffic data connection with the user terminal 110 through joining a shared network that includes the user terminal 110 (e.g., WIFI shared network or WIFI Direct), but may alternatively or additionally list WLAN devices that are not connected to the user terminal 110 but which have been discovered to be within communication range of a WLAN transceiver of the user terminal 110 through operations for discovering WLAN routers and other devices.

The user terminal 110 can therefore be configured to respond to an eCommerce transaction being initiated, e.g., by start-up of an eCommerce application hosted on the user terminal 110, but scanning to identify wireless devices that are observable by the user terminal 110. The user terminal 110 generate a list that identifies the wireless device identifiers, and which may furthermore identify for individual ones of the wireless device identifiers whether the wireless device identifier is for a wireless device has established a traffic data connection with the user terminal through successfully completing Bluetooth pairing, joining a WLAN network, etc. The list may identify for individual ones of the wireless device identifiers the type of radio access technology that is used for communications (e.g., NFC, Bluetooth, WIFI, etc.).

An application processed by the user terminal 110 can operate to generate the information which is communicated to the merchant node 120 for use in an eCommerce transaction. The user terminal 110 may be any electronic device that can communicate with a merchant node 120 including, but not limited to, a tablet computer, desktop computer, laptop computer, mobile phone, a point-of-sale merchant terminal, etc. The wireless devices may include, without limitation, a smart watch worn by the user who is operating the user terminal, car, a kitchen appliance (e.g., microwave oven, refrigerator, etc.), a desktop computer, television, a cable television tuner, a satellite television tuner, a home controller (e.g. door lock, temperature thermostat, light controller, etc.), a fire detector, a network security system, a washer or dryer, etc, that have a radio communication interface that emits signals observable (e.g., receivable, discoverable, etc.) by the user terminal 110.

Because of the prevalence of fraud occurring in eCommerce and other card-not-present financial transactions, where merchants cannot directly authenticate purchasers using picture IDs, electronic authentication processes have been introduced to authenticate purchasers. Electronic authentication processes can be performed by an authentication node 130 to attempt to confirm that the purchaser is an account owner or is otherwise authorized by the account owner.

If the merchant node 120 is registered for use of electronic authentication processes, the merchant node 120 generates an eCommerce authentication request containing content items (also referred to as “items of content”) that includes cardholder information, which can include one or more items of the cardholder information received from the user terminal 100, and further includes a user terminal identifier for the user terminal 110 and the list of wireless device identifiers of wireless devices 112a . . . 112c that are observed by the user terminal 110.

In accordance with some embodiments disclosed herein, the cardholder information contained as items of content of the eCommerce authentication request can include any one or more of:
1) account number (e.g., credit/debit card number);
2) expiration date for the card;
3) verification value (e.g., CVV);
4) cardholder's name;
5) the cardholder's home address;
6) the purchaser's shipping address;
7) characteristics of the purchaser's user terminal (e.g., manufacturer, web browser characteristics, and/or operational characteristics);
8) geographic region of the purchaser's user terminal;
9) amount of the financial transaction;
10) identifier for the merchant node 120;
11) a geographic region of the merchant node 120;
12) identifier for the acquirer node 122;
13) time of transaction; and
14) date of transaction.

The user terminal identifier for the user terminal 110 uniquely identifies the user terminal, such as by a telephone number of the user terminal, a International Mobile Subscriber Identity of the user terminal, and/or an identifier assigned to the mobile terminal 110 by an eCommerce application executed by the user terminal 110 or stored on the user terminal 110 during account setup/maintenance with the issuer node 140 and/or the merchant node 120. The user terminal identifier may be communicated from the user terminal 110 to the merchant node 120 or may determined by the merchant node 120 or another system component and included in the eCommerce authentication request.

The merchant node 120 communicates the eCommerce authentication request toward the authentication node 130 for authentication processing to authenticate the purchaser. The merchant node 120 may communicate the eCommerce authentication request using a software plug-in provided by a provider of the authentication node 130. Authentication of the purchaser can include determining whether the purchaser possesses secret information that should only be known to the account owner or another person who has been authorized by the account owner to make purchases using the account.

As will be explained in further detail below, an authentication gateway node 100 is disclosed herein that controls which eCommerce authentication requests from the merchant node 120 and other merchant nodes 120 cause authentication of purchasers. The authentication gateway node 100 may also generate a credit/debit account warning message which notifies a credit/debit finance issuer node 140 (e.g., card issuing bank server) that privileges with an account should be halted/frozen (e.g., cancel card) or otherwise modified.

The authentication gateway node 100 may intercept or otherwise receive the eCommerce authentication request from the merchant node 120 and determine whether authentication will be performed by the authentication node 130. The authentication gateway node 100 may, for example, selectively either route the eCommerce authentication request to the authentication node 130 for authentication or respond to the merchant node 120 without authentication by the authentication node 130 (e.g., some eCommerce authentication requests bypass the authentication node 130). Alternatively, the authentication gateway node 100 may mark the eCommerce authentication requests to indicate whether they are to be authenticated by the authentication node 130 (e.g., all eCommerce authentication requests flow through the authentication node 130 but only some cause authentication). These and other operations by the authentication gateway node 100 are described in further detail below.

Pursuant to one type of authentication process, the authentication node 130 communicates an authentication challenge message to the user terminal 110 which requires the purchaser to enter a security code to complete the purchase. The entered security code is returned to the authentication node 130 in a response message. The security code may be a password, personal identification number (PIN), electronic security token, or other secret information known to the account owner.

The authentication node 130 can compare the security code to an expected code, and apply one or more rules which may be defined by the card issuing bank (referred to more generally as the credit/debit finance issuer node 140 below) to generate an authentication response (e.g., authentication response code) that indicates an outcome of the authentication process.

One type of authentication process is known as a 3-D Secure protocol that can be performed by the authentication node 130 operating as a 3-D Secure authentication server. The 3-D Secure protocol was developed by financial card associations, including Visa and MasterCard, and has become an industry standard. The protocol uses XML messages sent over secure socket layer (SSL) connections between the user terminal 110 and the authentication node 130, which can also be referred to as an access control server (ACS). The authentication challenge can be presented through the user terminal 110 to the purchaser within the same web browser window as an in-line session (referred to as an inframe authentication session) or can be presented in a separate window (e.g., pop-up window).

An advantage to merchants of using purchaser authentication is a reduction in “unauthorized transaction” chargebacks. A disadvantage to merchants is that they pay a software setup fee, monthly fee, and per-authentication fee for use of the 3-D Secure access control server provided by the authentication node 130. Moreover, 3-D Secure operation can be complicated and create transaction failures.

Some purchasers view the additional authentication steps as a nuisance or obstacle to completing transactions and/or they erroneously interpret the authentication challenge (e.g., pop-up window) as originating from a fraudulent phishing site/process, which can result in a substantial increase in transaction abandonment by the purchaser and lost revenue to merchants. Some 3-D Secure authentication processes require the purchaser to complete an authentication registration process for the cardholder's financial account, including agreeing to all terms and conditions presented by 3-D Secure, before the purchaser can proceed with a purchase. Purchasers who are unwilling to undertake the risk or inconvenience of registering their card during a purchase, are forced to abandon the transaction. Moreover, some user terminals, such as those having mobile web browsers, can lack features (e.g, support for window frames and/or pop-ups) necessary for proper operation of a 3-D Secure authentication process.

For these and other reasons, some embodiments disclosed herein are directed to the authentication gateway node 100 generating risk scores for eCommerce authentication requests based on comparison of the reported list of wireless device identifiers from the user terminal 110 to a registered list of wireless device identifiers which has been associated with the user terminal identifier, and selectively providing the eCommerce authentication requests to the authentication node 130 based on the risk scores. The authentication gateway node 100 can include a risk score generator 104 that generates risk scores based on comparison of a reported list of wireless device identifiers, which is received as part of an eCommerce authentication request, to a registered list of wireless device identifiers that been obtained from a repository 102 containing lists of device identifiers that have been registered with user terminal identifiers.

The authentication gateway node 100 can be configured to operate on eCommerce authentication requests in-flight before being delivered to the authentication node 130, and control, based on the risk scores, which of the eCommerce authentication requests are processed by the authentication node 130 for authentication of purchasers and generation of authentication responses based on the outcomes of the authentication.

In one embodiment, only eCommerce authentication requests having risk scores that satisfy a defined rule are provided to the authentication node 130 for authentication processing and generation of the authentication responses based on the authentication processing, while other eCommerce authentication requests (having risk scores that do not satisfy the defined rule) bypass authentication processing by the authentication node 130. When bypassing authentication processing by the authentication node 130, the authentication gateway node 100 may generate an authentication response based on the risk score for the eCommerce authentication request (e.g., generate an authentication response indicating that the purchaser was properly authenticated) and communicate the authentication response to the merchant node 120 as if it had originated from the authentication node 130. When the authentication response is generated by the authentication gateway node 100, it may contain the same or similar content to an authentication response generated by the authentication node 130 so that the merchant node 120 is not aware that the authentication response was generated without authentication of the purchaser being performed by the authentication node 130.

When selectively providing the eCommerce authentication request to the authentication node 130, the authentication gateway node 100 may selectively mark the eCommerce authentication request to indicate whether authentication of the purchaser by the authentication node 130 is requested based on whether the risk score satisfies a defined rule. The authentication gateway node 130 then performs authentication processing (e.g., providing authentication challenges to purchasers) for only the eCommerce authentication requests that are marked for authentication. The authentication gateway node 130 can then generate the authentication responses based on a result of the authentication processing when performed, or based on the risk score when authentication processing is not performed.

In another embodiment, when selectively providing the eCommerce authentication request to the authentication node 130, the authentication gateway node 100 selectively routes the eCommerce authentication request to the authentication node 130 for authentication of the purchaser based on whether the risk score satisfies a defined rule. Accordingly, the authentication node 130 performs purchaser authentication processes for each eCommerce authentication request that it receives, however the authentication node 130 only receives eCommerce authentication requests having risk scores that the authentication gateway node 100 determined to satisfy a defined rule (e.g., having a risk score that exceeds a threshold level or alternatively that does not exceed a threshold level).

In another embodiment, the authentication node 130 can include some of the functionality described herein of the authentication gateway node 100. The authentication node 130 can receive all eCommerce authentication requests, but selectively generate an authentication challenge to the user equipment 110 (FIG. 1) to authenticate the purchaser only for eCommerce authentication requests having risk scores that satisfy a defined rule.

Depending upon the risk score, the authentication gateway node 100 may generate a credit/debit account warning message which notifies the credit/debit finance issuer node 140 (e.g., card issuing bank server) that privileges with an account should be halted/frozen (e.g., cancel card) or otherwise modified.

Although the authentication gateway node 100 is shown as being separate from the merchant node 120, in some embodiments the authentication gateway node 100 is incorporated into the credit/debit finance issuer node 140 or the merchant node 120 so that at least some of the operations disclosed herein as being performed by the authentication gateway node 100 are performed within the credit/debit finance issuer node 140 or the merchant node 120. Thus for example, the risk scores can be generated internal to the merchant node 120 and used to control when eCommerce authentication requests are communicated to the authentication node 130. The merchant node 120 can use the risk score to selectively send an eCommerce authentication request to the authentication node 130 for authentication of the purchaser when the risk score satisfies a defined rule or send the financial transaction to the acquirer node 122 and credit/debit finance issuer node 140 for verification against the cardholder's account without authentication of the purchaser by the authentication node 130 when the risk score does not satisfy a defined rule.

Similarly, although the authentication gateway node 100 is shown as being separate from the authentication node 130, in some embodiments the authentication gateway node 100 is incorporated into the authentication node 130 so that at least some of the operations disclosed herein as being performed by the authentication gateway node 100 are performed within the authentication node 130. Thus for example, the risk scores can be generated internal to the authentication node 130 and used to control which of the eCommerce authentication requests cause authentication challenges to be generated to purchasers.

The authentication response (e.g., 3-D Secure authentication response code) can be generated by the authentication node 130, based on authentication processes performed with the purchaser and/or may be generated by the authentication gateway node 100 based on the risk score (e.g., without authentication processing by the authentication node 130) and provided to the merchant node 120. The merchant node 120 receives the authentication response and may deny the transaction based on content of the authentication response (e.g., based on the risk score generated by the authentication gateway node 100 and/or based on the result of authentication processes by the authentication node). The merchant node 120 can initiate verification of the transaction by communicating to a credit/debit finance issuer node 140, via an acquirer node 122 (e.g., merchant's bank), the authentication response and content of the eCommerce authentication request (e.g., cardholder information, other content of an eCommerce authentication request disclosed herein, etc).

The acquirer node 122 routes the authentication response and the content of the eCommerce authentication request to a credit/debit finance issuer node 140 (e.g., card issuing bank server such as a Visa or other card server via VisaNet, BankNet, etc.). The credit/debit finance issuer node 140 generates an authorization decision based on whether the account number has a sufficient credit limit and/or existing funds to cover the amount of the financial transaction, and can further generate the authorization decision based on the authentication response from the authentication node 130 and/or the authentication gateway node 100.

The credit/debit finance issuer node 140 communicates its authorization decision to the acquirer node 122, which communicates an authorization decision to the merchant node 120. The merchant node 120 decides whether to complete the transaction with the purchaser or to deny the transaction based on the authorization decision from the acquirer node 122.

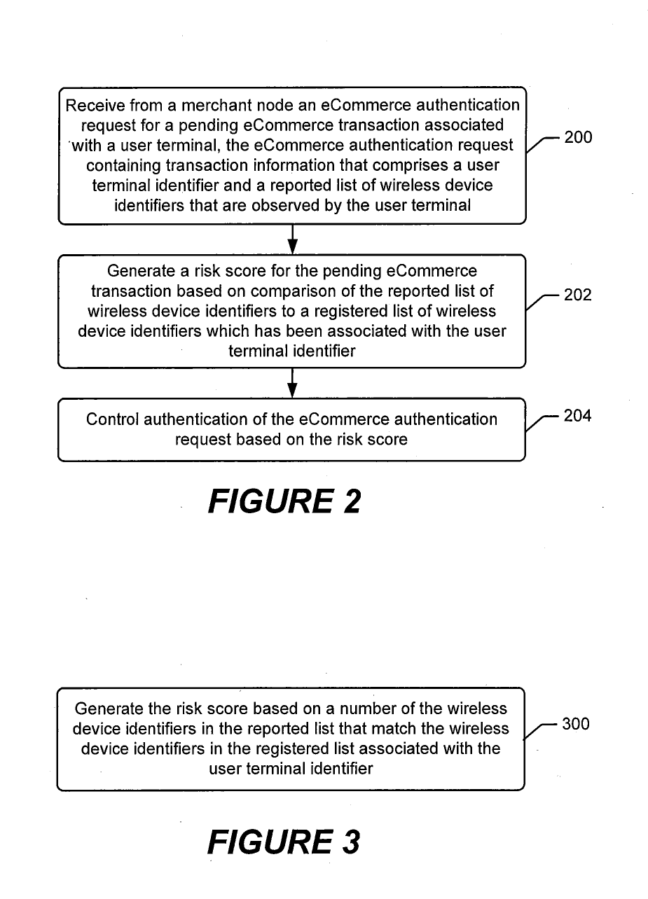

Further example operations by the authentication gateway node 100 are explained below with regard to FIGS. 2-10.

Referring to FIG. 2, the authentication gateway node 100 receives (block 200) from the merchant node 120 an eCommerce authentication request for a pending eCommerce transaction associated with the user terminal 110. The eCommerce authentication request contains transaction information that includes a user terminal identifier for the user terminal 110 and a reported list of wireless device identifiers that are observed by the user terminal 110. The node 100 generates (block 202) a risk score for the pending eCommerce transaction based on comparison of the reported list of wireless device identifiers to a registered list of wireless device identifiers which has been associated with the user terminal identifier. The node 100 controls (block 204) authentication of the eCommerce authentication request based on the risk score.

Controlling (block 204) authentication can include selectively providing the eCommerce authentication request to an authentication node 130 based on the risk score. Authentication may be controlled (block 204) by selectively marking the eCommerce authentication request to indicate whether authentication of the purchaser by the authentication node 130 is requested, based on whether the risk score satisfies a defined rule. Alternatively, authentication may be controlled (block 204) by selectively routing the eCommerce authentication request to the authentication node 130 for authentication of the purchaser based on whether the risk score satisfies a defined rule.

The authentication gateway node 100 may use further information when generating the risk score. In one embodiment, the risk score is generated based on comparison of the reported list of wireless device identifiers to the registered list of wireless device identifiers, and further based on a financial account number, a transaction amount, an expiration date for a card associated with the financial account number, a verification value, and a cardholder's name contained in the eCommerce authentication request. Additional or other information may be used when generating the risk score in accordance with various embodiments disclosed herein.

In the alternative embodiment of FIG. 3, the authentication gateway node 100 generates the risk score based on a number of the wireless device identifiers in the reported list, received in the eCommerce authentication request, that match the wireless device identifiers in the registered list associated with the user terminal identifier. For example, the risk score may be generated to indicate a lower risk of fraud when at least a threshold number of matches are identified between wireless device identifiers in the reported list and wireless device identifiers in registered list. The resource may alternatively be generated based on how many matches are identified between wireless device identifiers in the reported in registered lists, with a greater number of matches corresponding to a lower risk of fraud being indicated by the generated risk score.

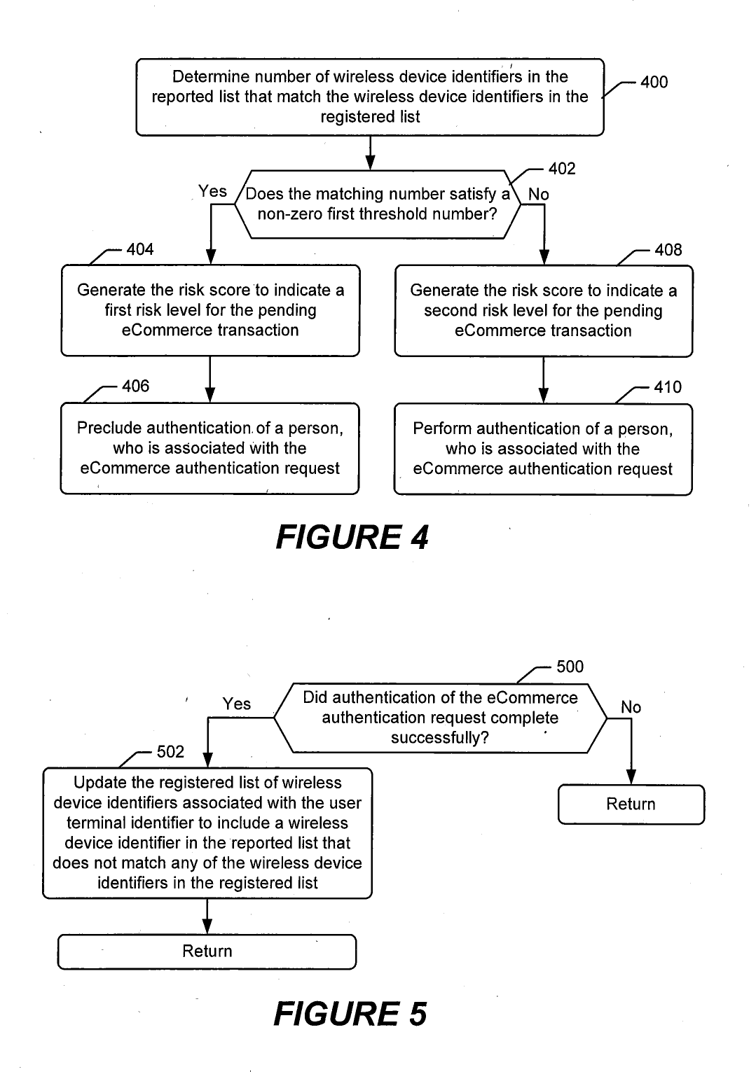

In the alternative embodiment of FIG. 4, the authentication gateway node 100 determines (block 400) a number of wireless device identifiers in the reported list that match the wireless device identifiers in registered list. Based on determining (block 402) that the number of matches satisfies a non-zero threshold number, the risk score is generated (block 404) to indicate a first risk level for the pending eCommerce transaction and which precludes (block 406) authentication of a person who is associated with the eCommerce authentication request. In sharp contrast, based on determining (block 402) that the number of matches does not satisfy the non-zero threshold number, the risk score is generated (408 404) to indicate a second risk level for the pending eCommerce transaction and which causes authentication of a person who is associated with the eCommerce authentication request to be performed (block 410). Thus, for example, when the user terminal 110 observes more than 2 wireless devices that have been earlier registered as being associated with the user terminal 110, the risk score can be set to cause authentication of the purchaser for an eCommerce transaction to be skipped. In contrast, when the user terminal 110 observes less than 2 wireless devices that have been earlier registered as being associated with the user terminal 110, the risk score can be set to cause authentication of the purchaser for an eCommerce transaction to be performed.

The risk score may additionally or alternatively be generated based on identifying a match between one of the wireless device identifiers in the reported list and one of the wireless device identifiers in the registered list, and determining a type of radio access technology used by the user terminal to communicate with a wireless device having the one of the wireless device identifiers. The risk score can then be generated based on the type of radio access technology. The risk score may be generated based on a maximum communication range associated with the various radio access technologies. The risk of fraud associated with an eCommerce transaction may be determined based on an inverse proportional relationship to the maximum communication range of the radio access technology is used by the user terminal 110 to communicate with the wireless device.

For example, at a first time the user terminal 110 reports as part of an eCommerce transaction request that it presently observes a Bluetooth connected device identifier which is determined to match a device identifier in the registered list. In a second time the user terminal 110 reports as part of an eCommerce transaction request that it presently observes a WLAN connected device identifier which is determined to match a device identifier in the registered list. The shorter range and lower power nature of the Bluetooth protocol compared to the WLAN protocol makes it more likely that the Bluetooth connected device identifier is owned by the same person who owns the user terminal 110. The WLAN connected device identifier may be a WLAN router that is owned by a business where the user is a customer and is simultaneously shared with many other persons. The eCommerce transaction arising at the first time is therefore determined to have a lower risk of fraud based on the Bluetooth connectivity to the wireless device compared to the eCommerce transaction arising at the second time having WLAN connectivity to the wireless device.

In one embodiment, the risk score can be generated to indicate a first risk level for the pending eCommerce transaction based on the type of radio access technology being a Bluetooth protocol. In contrast, the risk score can be generated to indicate a second risk level for the pending eCommerce transaction based on the type of radio access technology being a wireless local area network protocol, where the first risk level indicates a lower fraud risk for the pending eCommerce transaction than the second risk level.

The risk score may be generated to indicate a lower risk when the user terminal 110 has successfully completed Bluetooth pairing to the reported wireless device versus when the reported wireless device is discovered by the user terminal 110 but has not been paired. Similarly, the risk score may be may be generated to indicate a lower risk when the user terminal 110 has successfully completed operations to join a WLAN network including the reported wireless device versus when the reported wireless device is discovered by the user terminal 110 but has not been joined thereto on a shared network.

The risk score may be generated based on how many wireless device identifiers in the reported list from the user terminal 110 match wireless device identifiers in the registered list for that user terminal 110. The contributions of any of the wireless device identifiers to the risk score may be based on whether the wireless device having the wireless device identifiers is identified in the list as having established a traffic data connection with the user terminal 110. The risk score may be generated with wireless device identifiers associated with an established traffic data connection to the user terminal 110 (e.g., paired or joined to a shared network) providing a greater contribution to generation of a lower risk score than wireless device identifiers that are discovered by the user terminal 110 but which have not established a traffic data connection to the user terminal 110 (e.g., not paired or not joined to a shared network).

The authentication gateway node 100 can update the repository 102 based on receiving feedback of whether authentication of eCommerce authentication requests completed successfully. Wireless device identifiers that were reported as part of eCommerce authentication requests that successfully completed authentication, e.g., by the authentication node 130, can be added to the respective lists in the repository 102 with an association to the user terminal identifiers associated with those eCommerce authentication requests. In the embodiment of FIG. 5, the authentication gateway node 100 determines (block 500) whether authentication of an eCommerce authentication request completed successfully. When completed successfully, the authentication gateway node 100 can update the registered list of wireless device identifiers associated with the user terminal identifier within the repository 102 to include a wireless device identifier in the reported list that does not match any of the wireless device identifiers in the registered list.

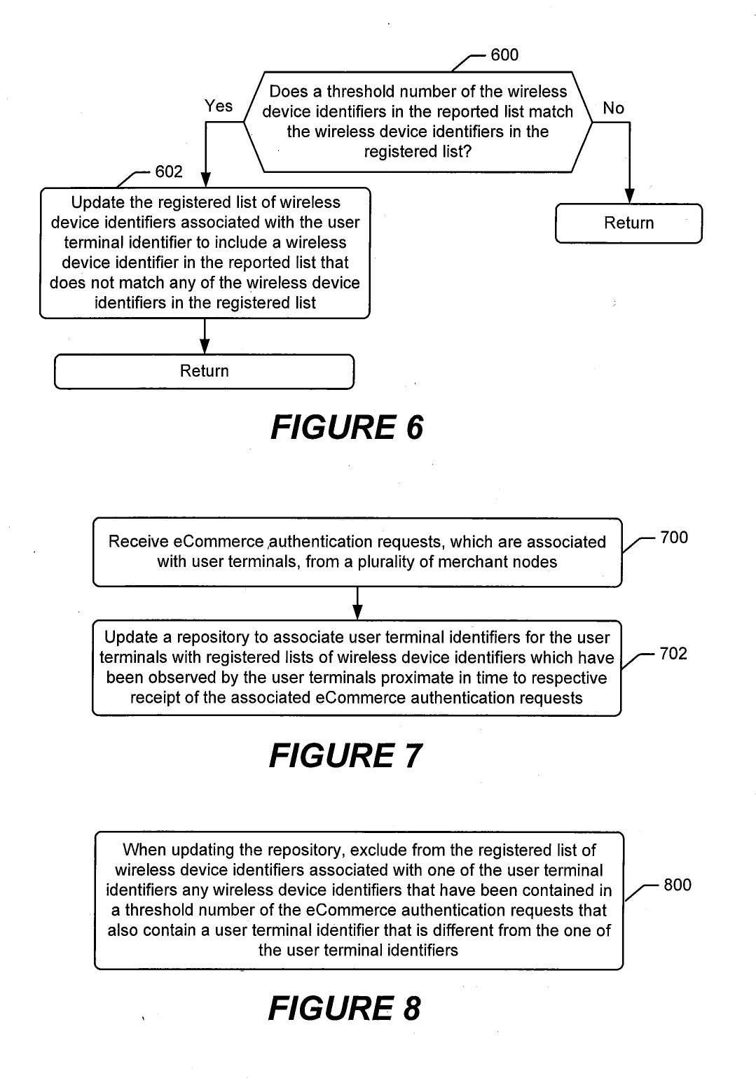

In the alternative embodiment of FIG. 6, the authentication gateway node 100 can update the repository 102 based on determining (block 600) whether a threshold number of the wireless device identifiers in the reported list match the wireless device identifiers in registered list in the repository 102. Based on the determination (block 600) being satisfied, the registered list of wireless device identifiers (stored in the repository 12) associated with the user terminal identifier is updated to include a wireless device identifier in the reported list that does not match any of the wireless device identifiers in the registered list.

The repository 102 can be updated based on eCommerce authentication request received from numerous different merchant nodes 120. Referring to FIG. 7, responsive to content of eCommerce authentication requests received (block 700) from merchant nodes 120, the repository 102 is updated (block 702) to associate user terminal identifiers for the user terminals 110 with registered lists of wireless device identifiers which have been observed by the user terminals 110 proximate in time to respective receipt of the associated eCommerce authentication requests. The risk score for the pending eCommerce transaction is generated based on comparison of the reported list of wireless device identifiers to the registered list of wireless device identifiers which is retrieved from the repository using the user terminal identifier.

In the embodiment of FIG. 8, when updating the repository 102, the gateway node 100 excludes (block′800) from the registered list of wireless device identifiers associated with one of the user terminal identifiers, any wireless device identifiers that have been contained in a threshold number of the eCommerce authentication requests that also contain a user terminal identifier that is different from the one of the user terminal identifiers. Thus, for example, when various different purchasers operate different user terminals 110 while located at a same business having a customer-available WLAN for Internet access, the user terminals 110 both report the same wireless device identifier for the business' WLAN device. The gateway node 100 determines that the same wireless device identifier for the WLAN device is contained in more than the threshold number of eCommerce authentication request from the different user terminals 110 and, responsively, does not add the wireless device identifier for the WLAN device to any of the lists associated with the user terminal identifiers for those user terminals 110. The WLAN device identifier is not added to any of the registered list for the user terminals because the WLAN device is deemed to not be sufficiently personally associated with an owner of any one of the user terminals 110 but instead is a publicly shared device. Identifying presence of a publicly shared device to a user terminal 110 may not in some embodiments affect the risk score associated with an eCommerce transaction. In some other embodiments, the WLAN device identifier is added to the lists but is used as a part of a pattern of wireless device identifiers that when observed concurrently indicates a lower risk associated with an eCommerce transaction.

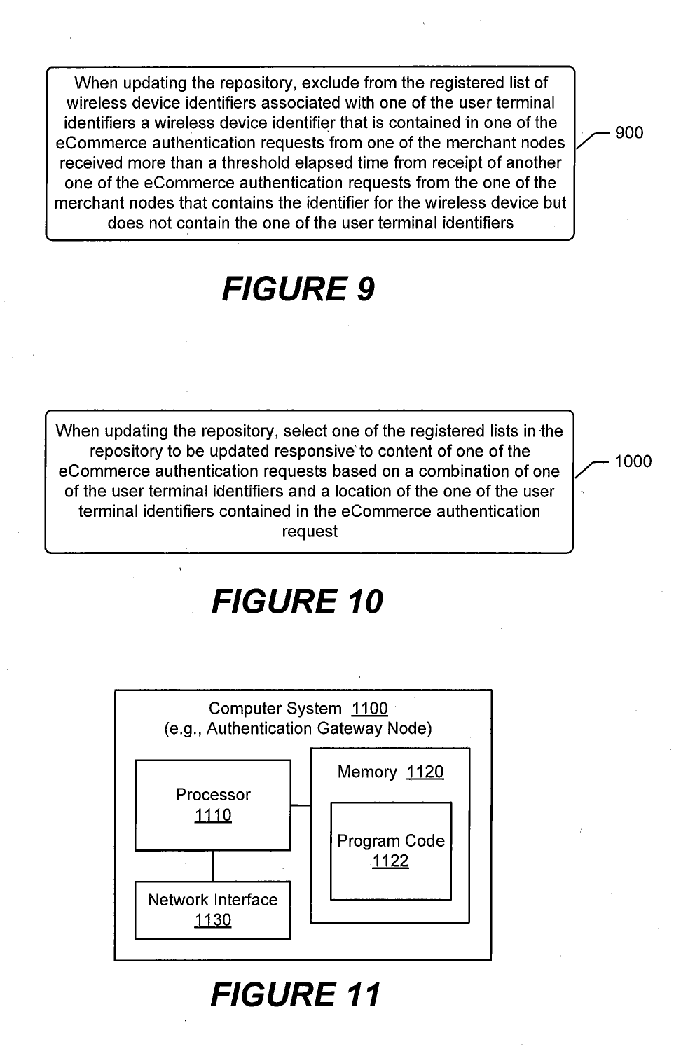

In the embodiment of FIG. 9, when updating the repository 102, the gateway node 100 excludes (block 900) from the registered list of wireless device identifiers associated with one of the user terminal identifiers, a wireless device identifier that is contained in one of the eCommerce authentication requests from one of the merchant nodes received more than a threshold elapsed time from receipt of another one of the eCommerce authentication requests from the one of the merchant nodes that contains the identifier for the wireless device but does not contain the one of the user terminal identifiers. As with the embodiment of FIG. 9, the gateway node 100 seeks to distinguish between wireless devices that appear to be personally associated with, e.g., owned by, an owner of the user terminal 110 versus other wired devices that are observable by the user terminal 110 but are not likely to be personally associated with the owner. In the embodiment of FIG. 9, the gateway node identifies when multiple eCommerce authentication requests from a same merchant node 120 are spaced apart by more than a threshold elapsed time and are associated with different user terminals but contain a same wireless device identifier. The wireless device identifier is not added to the registered list for the user terminals because the wireless device is likely not personally associated with either user terminal in a way that should affect the determination of risk associated with an eCommerce transaction arising from the user terminal. Alternatively, in some other embodiments, the wireless device identifier is added to the lists but is used as a part of a pattern of wireless device identifiers that when observed concurrently indicates a lower risk associated with an eCommerce transaction.

In the embodiment of FIG. 10, when updating the repository 102 based on selecting (block 1000) one of the registered lists in the repository 102 to be updated responsive to content of one of the eCommerce authentication requests based on a combination of one of the user terminal identifiers and a location of the one of the user terminal identifiers contained in the eCommerce authentication request.

FIG. 11 is a block diagram of a computer system 1100 that may be used as an authentication gateway node 100, an authentication node 130, a merchant node 120, an acquirer node 122, a user terminal 110, and/or a credit/debit finance issuer node 140 to perform the operations of one of more of the embodiments disclosed herein for one or more of those elements. The computer system 1100 can include one or more network interface circuits 1130, one or more processor circuits 1110 (referred to as “processor” for brevity), and one or more memory circuits 1120 (referred to as “memory” for brevity) containing program code 1122.

The processor 1110 may include one or more data processing circuits, such as a general purpose and/or special purpose processor (e.g., microprocessor and/or digital signal processor) that may be collocated or distributed across one or more networks. The processor 1110 is configured to execute program code 1122 in the memory 1120, described below as a computer readable storage medium, to perform some or all of the operations for one or more of the embodiments disclosed herein.

When configured as a user terminal 110, the system 1100 includes one or more radio transceivers configured to communicate with wireless devices 112 using one or more radio access technologies. The radio access technologies may include, but are not limited to, Near Field Communication (NFC), Bluetooth, WLAN (IEEE 802.11), 3GPP Long Term Evolution (LTE), etc.

### Further Definitions and Embodiments

In the above-description of various embodiments of the present disclosure, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented in entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., dr any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

It is to be understood that the terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Like reference numbers signify like elements throughout the description of the figures.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

1. A method comprising:
performing operations as follows on a processor of a financial transaction processing system:
receiving from a merchant node an eCommerce authentication request for a pending eCommerce transaction associated with a user terminal, the eCommerce authentication request containing transaction information that comprises a user terminal identifier and a reported list of device identifiers that are observed by the user terminal;
generating a risk score for the pending eCommerce transaction based on comparison of the reported list of wireless device identifiers to a registered list of wireless device identifiers which has been associated with the user terminal identifier; and
controlling authentication of the eCommerce authentication request based on the risk score.

2. The method of claim 1, wherein the controlling authentication of the eCommerce authentication request based on the risk score, comprises:
selectively providing the eCommerce authentication request to an authentication node based on the risk score.

3. The method of claim 2, wherein the selectively providing the eCommerce authentication request to the authentication node based on the risk score, comprises:
selectively marking the eCommerce authentication request to indicate whether authentication of a person, who is associated with the pending eCommerce transaction, by the authentication node is requested, based on whether the risk score satisfies a defined rule.

4. The method of claim 2, wherein the selectively providing the eCommerce authentication request to the authentication node based on the risk score, comprises:
selectively routing the eCommerce authentication request to the authentication node for authentication of a person, who is associated with the pending eCommerce transaction, based on whether the risk score satisfies a defined rule.

5. The method of claim 1, wherein the generating a risk score for the pending eCommerce transaction based on comparison of the reported list of wireless device identifiers to the registered list of wireless device identifiers which has been associated with the user terminal identifier, comprises:
generating the risk score based on comparison of the reported list of wireless device identifiers to the registered list of wireless device identifiers, and further based on a financial account number, a transaction amount, an expiration date for a card associated with the financial account number, a verification value, and a cardholder's name contained in the eCommerce authentication request.

6. The method of claim 1, wherein the generating a risk score for the pending eCommerce transaction based on comparison of the reported list of wireless device identifiers to the registered list of wireless device identifiers which has been associated with the user terminal identifier, comprises:
generating the risk score based on a number of the wireless device identifiers in the reported list that match the wireless device identifiers in the registered list associated with the user terminal identifier.

7. The method of claim 1, wherein:
the generating a risk score for the pending eCommerce transaction based on comparison of the reported list of wireless device identifiers to the registered list of wireless device identifiers which has been associated with the user terminal identifier, comprises:
generating the risk score to indicate a first risk level for the pending eCommerce transaction based on a non-zero threshold number of the wireless device identifiers in the reported list matching the wireless device identifiers in the registered list; and
generating the risk score to indicate a second risk level for the pending eCommerce transaction based on less than the non-zero threshold number of the wireless device identifiers in the reported list matching the wireless device identifiers in the registered list; and
the controlling authentication of the eCommerce authentication request based on the risk score comprises:
performing authentication of a person, who is associated with the eCommerce authentication request, responsive to the risk score indicating the second risk level; and
precluding authentication of a person, who is associated with the eCommerce authentication request, responsive to the risk score indicating the first risk level.

8. The method of claim 1, further comprising:
based on determining that authentication of the eCommerce authentication request was completed successfully, updating the registered list of wireless device identifiers associated with the user terminal identifier to include a wireless device identifier in the reported list that does not match any of the wireless device identifiers in the registered list.

9. The method of claim 1, further comprising:
based on determining that a non-zero threshold number of the wireless device identifiers in the reported list match the wireless device identifiers in the registered list, updating the registered list of wireless device identifiers associated with the user terminal identifier to include a wireless device identifier in the reported list that does not match any of the wireless device identifiers in the registered list.

10. The method of claim 1, wherein the generating a risk score for the pending eCommerce transaction based on comparison of the reported list of wireless device identifiers to a registered list of wireless device identifiers which has been associated with the user terminal identifier, comprises:
identifying a match between one of the wireless device identifiers in the reported list and one of the wireless device identifiers in the registered list;
determining a type of radio access technology used by the user terminal to communication with d wireless device having the one of the wireless device identifiers; and
generating the risk score based on the type of radio access technology.

11. The method of claim 10, wherein the generating the risk score based on the type of radio communication technology, comprises:
generating the risk score to indicate a first risk level for the pending eCommerce transaction based on the type of radio access technology being a Bluetooth protocol; and
generating the risk score to indicate a second risk level for the pending eCommerce transaction based on the type of radio access technology being a wireless local area network protocol, wherein the first risk level indicates a lower fraud risk for the pending eCommerce transaction than the second risk level.

12. The method of claim 1, further comprising:
responsive to content of eCommerce authentication requests, which are associated with user terminals, received from a plurality of merchant nodes, updating a repository to associate user terminal identifiers for the user terminals with registered lists of wireless device identifiers which have been observed by the user terminals proximate in time to respective receipt of the associated eCommerce authentication requests,
wherein the risk score for the pending eCommerce transaction is generated based on comparison of the reported list of wireless device identifiers to the registered list of wireless device identifiers which is retrieved from the repository using the user terminal identifier.

13. The method of claim 12, wherein:
the updating excludes from the registered list of wireless device identifiers associated with one of the user terminal identifiers any wireless device identifiers that have been contained in a threshold number of the eCommerce authentication requests that also contain a user terminal identifier that is different from the one of the user terminal identifiers.

14. The method of claim 12, wherein:
the updating excludes from the registered list of wireless device identifiers associated with one of the user terminal identifiers a wireless device identifier that is contained in one of the eCommerce authentication requests from one of the merchant nodes received more than a threshold elapsed time from receipt of another one of the eCommerce, authentication requests from the one of the merchant nodes that contains the identifier for the wireless device but does not contain the one of the user terminal identifiers.

15. The method of claim 12, wherein:
the updating comprises selecting one of the registered lists in the repository to be updated responsive to content of one of the eCommerce authentication requests based on a combination of one of the user terminal identifiers and a location of the one of the user terminal identifiers contained in the eCommerce authentication request.

16. A computer node of a financial transaction processing system comprising:
a processor; and
a memory coupled to the processor and comprising computer readable program code that when executed by the processor causes the processor to perform operations comprising:
receiving from a merchant node an eCommerce authentication request for a pending eCommerce transaction associated with a user terminal, the eCommerce authentication request containing transaction information that comprises a user terminal identifier and a reported list of wireless device identifiers that are observed by the user terminal;
generating a risk score for the pending eCommerce transaction based on comparison of the reported list of wireless device identifiers to a registered list of wireless device identifiers which has been associated with the user terminal identifier; and
controlling authentication of the eCommerce authentication request based on the risk score.

17. The computer node of the financial transaction processing system of claim 16, wherein:
the generating a risk score for the pending eCommerce transaction based on comparison of the reported list of wireless device identifiers to the registered list of wireless device identifiers which has been associated with the user terminal identifier, comprises:
generating the risk score to indicate a first risk level for the pending eCommerce transaction based on a non-zero first threshold number of the wireless device identifiers in the reported list matching the wireless device identifiers in the registered list; and
generating the risk score to indicate a second risk level for the pending eCommerce transaction based on less than the non-zero first threshold number of the wireless device identifiers in the reported list matching the wireless device identifiers in the registered list; and
the controlling authentication of the eCommerce authentication request based on the risk score comprises:
performing authentication of a person, who is associated with the eCommerce authentication request, responsive to the risk score indicating the second risk level; and
precluding authentication of a person, who is associated with the eCommerce authentication request, responsive to the risk score indicating the first risk level.

18. A user terminal comprising:
a radio transceiver configured to communicate with wireless devices;
a processor; and
a memory coupled to the processor and comprising computer readable program code that when executed by the processor causes the processor to perform operations comprising:
generating a list of wireless device identifiers for wireless devices that are presently observable by the radio transceiver;
generating an eCommerce authentication request for a pending eCommerce transaction, the eCommerce authentication request comprising the list of wireless device identifiers, an account number, and an amount of the pending eCommerce transaction; and
communicating the eCommerce authentication request to a merchant node.
